(19) United States
(12) Patent Application Publication
(10) Pub. No.: US 2026/0140473 A1
(43) Pub. Date: May 21, 2026

(54) IMAGE FORMING APPARATUS

(71) Applicant: CANON KABUSHIKI KAISHA, Tokyo (JP)

(72) Inventor: SHUJI SAITO, Shizuoka (JP)

(21) Appl. No.: 19/394,255

(22) Filed: Nov. 19, 2025

(30) Foreign Application Priority Data
Nov. 20, 2024 (JP) 2024-202822

(51) Int. Cl. G03G 15/00; G03G 15/01; G03G 15/02; G03G 21/00

(52) U.S. Cl. CPC G03G 15/80; G03G 15/0121; G03G 15/0131; G03G 15/0178; G03G 15/0233; G03G 21/0035; G03G 21/0064

(57) ABSTRACT

An image forming apparatus includes a photosensitive member, a charging member, a developing portion, a transfer portion, a collecting member provided downstream of the transfer portion and upstream of the charging member with respect to the rotational direction, and a controller for control ling voltages applied to the charging member and the collecting member, respectively. Absolute values of potentials of the collecting member and a surface potential of the photosensitive member before passing through the collecting member are defined as V1 and V2, respectively. The controller controls the voltages applied to the charging member and the collecting member so that i) V2<V1 is satisfied and (V1−V2) is less than a discharge threshold, and ii) a potential difference formed between the charging member and the surface of the photosensitive member charged by the collecting member is equal to or higher than a discharge starting voltage.

### BACKGROUND

### Field of the Technology

The present disclosure relates to an image forming apparatus for forming an image on a sheet.

### Description of the Related Art

According to Japanese Laid-Open Patent Application (JP-A) No. 2019-40141, an image forming apparatus of a tandem type in which four photosensitive drums for bearing toner images of different colors from each other are provided with respect to a movement direction of an intermediary transfer belt is pressed.

In this image forming apparatus, a cleaner-less type in which a cleaning device for removing transfer residual toner remaining on the photosensitive drum after transfer of the toner image is omitted and in which the transfer residual toner is collected in a developing portion is employed. In such a constitution, a phenomenon which is called reverse transfer such that a toner image transferred from an upstream-side photosensitive drum onto an intermediary transfer belt is moved to a downstream-side photosensitive drum when the toner image passes through a position where the downstream-side photosensitive drum and the intermediary transfer belt are in contact with each other occurs in some instances. The reverse transfer occurs due to that a polarity of toner of the toner image to be reversely transferred is reversed by electric discharge generating between the photosensitive drum and the intermediary transfer belt.

In the image forming apparatus employing the cleaner-less type as in the above-described JP-A No. 2019-40141, in many cases, the toner reversely transferred on the photosensitive drum is deposited on a charging roller which is a charging member. When the toner in a large amount is deposited on a surface of the charging roller, a charging performance is changed and a drum potential is deviated from a desired drum potential in some instances.

### SUMMARY

Therefore, the present disclosure is directed to provide an image forming apparatus capable of suppressing an image defect due to toner reversely transferred on a photosensitive member.

According to an aspect of the present disclosure, there is provided an image forming apparatus in which a first toner image having a first color is formed and a second toner image having a second color different from the first color is transferred onto a toner image receiving member so as to be superposed on the first toner image, the image forming apparatus comprising: a photosensitive member rotatable in a predetermined rotational direction; a charging member configured to electrically charge a surface of the photosensitive member in contact with the surface of the photosensitive member; a developing portion configured to develop an electrostatic latent image, formed on the surface of the photosensitive member, into the second toner image; a transfer portion configured to transfer the second toner image onto the toner image receiving member; a collecting member provided downstream of the transfer portion and upstream of the charging member with respect to the rotational direction and configured to electrostatically collect reversely transferred toner which is transferred from the toner image receiving member onto the surface of the photosensitive member by the transfer portion and which has the first color; and a controller configured to control voltages applied to the charging member and the collecting member, respectively, wherein an absolute value of a potential of the collecting member during image formation is defined as V1, and an absolute value of a surface potential of the photosensitive member before passing through the collecting member is defined as V2, and wherein the controller controls each of the voltages applied to the charging member and the collecting member so that i) V2<V1 is satisfied and (V1−V2) is less than a discharge threshold, and ii) a potential difference formed between the charging member and the surface of the photosensitive member charged by the collecting member is equal to or higher than a discharge starting voltage.

Features of the present disclosure will become apparent from the following description of embodiments with reference to the attached drawings. The following description of embodiments are described by way of example.

### BRIEF DESCRIPTION OF THE DRAWINGS

FIG. 1 is a schematic general view showing an image forming apparatus according to an embodiment.

FIG. 2 is a sectional view showing a layer structure of a photosensitive drum.

FIG. 3 is a schematic view showing a comb-type electrode.

FIG. 4 is a schematic view showing a peripheral constitution of a photosensitive drum 1 in an embodiment 3.

FIG. 5 is a block diagram showing control blocks of the image forming apparatus.

### DESCRIPTION OF THE EMBODIMENTS

### (1. Image Forming Apparatus Constitution)

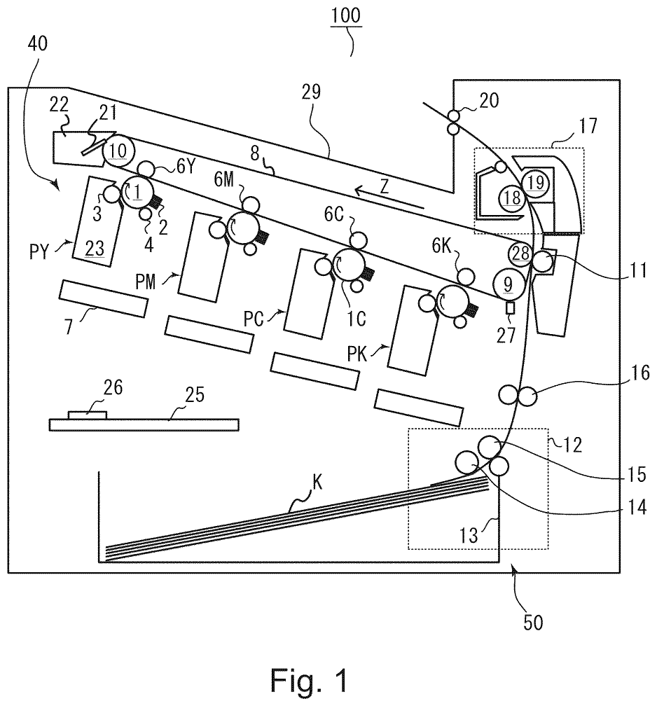

FIG. 1 is a schematic general view of an image forming apparatus 100, according to an embodiment, in which process cartridges PY to PK are mounted. In this embodiment, the image forming apparatus 100 is a laser beam printer of an electrophotographic process type, which is capable of forming an image at a process speed 310 [mm/sec], a Letter-size throughput of 60 [ppm] and a resolution of 600 [dpi] and which is adaptable to Letter-size paper.

The image forming apparatus 100 shown in FIG. 1 includes an image forming portion 40, a sheet feeding portion 50, and a fixing device 17. A sheet K includes paper such as a sheet or an envelope, a plastic film such as a sheet for an overhead projector (OHP), a cloth, and the like. The image forming apparatus refers to an apparatus includes a printer, a copying machine, a facsimile apparatus, and a multi-function machine, and refers to an apparatus for forming the image on the sheet such as a recording medium on the basis of image information inputted from an external PC or image information read from an original. Further, in addition to a main assembly having an image forming function, to the image forming apparatus, attached equipment such as an operation feeder, an image reading apparatus, a sheet processing device, or the like is connected in some cases, but entirety of a system in which the attached equipment as described above is connected to the main assembly is also a kind of the image forming apparatus.

The image forming portion 40 includes the four process cartridges PY, PM, PC, and PK for forming toner images of four colors of yellow (Y), magenta (M), cyan (C), and black (K), respectively, and a laser scanner 7.

Incidentally, the four process cartridges PY, PM, PC, and PK have the same constitutions except that the colors of the formed images are different from each other. For that reason, only a constitution and an image forming process of the process cartridge PY will be described and description of the process cartridges PM, PC, and PK will be omitted.

The process cartridge PY includes a photosensitive drum 1 as a photosensitive member, a temporary collecting brush 2, a developing roller 3, a toner container 23 accommodating the developing roller 3, a charging roller 4, and a pre-exposure device 5. The photosensitive drum 1 is a cylinder which has a diameter of 24 [mm] and which includes a plurality of functional layers. The photosensitive drum 1 is constituted so as to be rotatable in a predetermined direction which is an arrow direction shown in FIG. 1. A constitution of the photosensitive drum 1 will be described specifically later.

The temporary collecting brush 2 is press-contacted to a predetermined pressing force and forms a brush nip. The temporary collecting brush 2 is a bar brush prepared by applying raw fabric of 5 [mm] in width, obtained by processing electroconductive nylon fibers into pile fabric, to a plated steel plate (metal plate). In other words, the temporary collecting brush 2 is constituted by a supporting member constituted by the metal plate and fibers mounted to the supporting member and having electroconductivity, and includes a brush portion with which the photosensitive drum 1 is rubbed. To the temporary collecting brush 2, a voltage of a negative polarity is applied by an unshown voltage applying portion. A constitution and an applied voltage of the temporary collecting brush 2 will be described specifically later.

The charging roller 4 as a charging member is disposed downstream of the temporary collecting brush 2 with respect to a rotational direction of the photosensitive drum 1. The charging roller 4 is a rubber roller of 8 [mm] in diameter prepared by molding an electroconductive rubber on a metal shaft. The charging roller 4 is press-contacted to the photosensitive drum 1 by a predetermined pressing force, and forms a charging nip. The charging roller 4 has a constitution in which a charging voltage is applied thereto by an unshown voltage applying portion. In this embodiment, to the charging roller 4, a charging voltage of −1070 [V] is applied during image formation. Details of the constitution of the charging roller 4 will be described later.

The developing roller 3 as a developing portion is a rubber roller prepared by molding an electroconductive rubber on a metal shaft and is press-contacted to the photosensitive drum 1 by a predetermined pressing force, thus forming a developing nip. The developing roller 3 is driven by an unshown driving means so as to be rotatable at a speed faster than the speed of the photosensitive drum 1. Further, the developing roller 3 is constituted so as to be capable of transition between a contact state in which the developing roller 3 is contacted to the photosensitive drum 1 and a separation state in which the developing roller 3 is separated from the photosensitive drum 1. To the developing roller 3, a voltage of the negative polarity is applied by an unshown voltage applying portion, and in this embodiment, a developing voltage of −320 [V] is applied during the image formation.

The laser scanner 7 irradiates the photosensitive drum 1 with laser light on the basis of an image signal, so that the photosensitive drum 1 is exposed to the laser light. Incidentally, in this embodiment, four laser scanners are provided one by one for the photosensitive drums 1 of the four process cartridges, but a single laser scanner may also include four light emitting portions.

The photosensitive drum 1 is electrically charged to a dark-portion potential of a predetermined negative polarity by applying the voltage of the predetermined negative polarity. In a portion of the photosensitive drum 1 where the photosensitive drum 1 is exposed to the laser light emitted from the laser scanner 7, a surface potential lowers, so that an electrostatic latent image having a predetermined light-part potential is formed.

Incidentally, in the following, a portion where the photosensitive drum 1 is charged to a dark-portion potential (Vd) is referred to as a dark portion Vd, and a portion where the photosensitive drum 1 is charged to a light-portion potential (Vl) is referred to as a light portion Vl.

To the developing roller 3, a predetermined voltage (Vdc) of the negative polarity is applied, and an appropriate potential difference is provided between the dark portion Vd and the light portion Vl, so that when the electrostatic latent image passes through the developing nip, the toner on the developing roller 3 is transferred onto only the light portion Vl and the electrostatic latent image is visualized. A difference between the voltage (Vdc) applied to the developing roller 3 and the light-portion potential (Vl) of the photosensitive drum 1 is referred to as a developing contrast, and by this potential difference, a toner amount of the toner moved from the developing roller 3 onto the photosensitive drum 1 can be controlled. Further, a difference between the dark-portion (Vd) of the photosensitive drum 1 and the voltage (Vdc) applied to the developing roller 3 is referred to as a back contrast, and by this potential difference, an occurrence of a fog such that unnecessary toner is moved to a non-exposure portion of the photosensitive drum 1, i.e., the dark portion Vd is suppressed. In this embodiment, by setting Vd=−520 [V], Vl=−120 [V], and Vdc=−320 [V], a setting such that each of the developing contrast and the back contrast becomes 200 [V] was employed.

The toner used in this embodiment is constituted by externally adding silica fine particles of 20 [nm] in average particle size to toner particles of 6.4 [μm] in average particle size and are charged to the negative polarity. The average particle size refers to an average particle size acquired from a particle volume capable of being measured by, for example, the Coulter method.

Further, in the image forming portion 40, an intermediary transfer belt 8 wound around a driving roller 9, a tension roller 10, and an opposite roller 28 is provided, and inside the intermediary transfer belt 8, primary transfer rollers 6Y, 6M, 6C, and 6K are provided. Each of the primary transfer rollers 6Y, 6M, 6C, and 6K as a transfer portion is disposed so as to oppose the associate one of the photosensitive drums 1 of the process cartridges. The intermediary transfer belt 8 as a toner image receiving member (transfer-receiving member) is an endless belt consisting of resin materials in two layers obtained by coating a 2 [μm]-thick resin surface layer on a 60 [μm]-thick base layer, and is rotated in an arrow Z direction by the driving roller 9. To each of the primary transfer rollers 6Y, 6M, 6C, and 6K, a transfer voltage of a positive polarity is applied by an unshown voltage applying portion, and in this embodiment, a transfer voltage of +300 [V] is applied during the image formation.

The fixing device 17 includes a fixing film 18 heated by an unshown heater and a pressing roller 19 press-contacted to the fixing film 18. The sheet feeding portion 50 is provided in a lower portion of the image forming apparatus 100 and includes a cassette 13 supporting sheets, a feeding roller 14 for feeding the sheets, and a conveying roller pair 15. The feeding roller 14 and the conveying roller pair 15 constitute a feeding/conveying device 12.

Next, an image forming operation of the thus-constituted image forming apparatus 100 will be described. When an image signal is inputted to the laser scanner 7 from an unshown personal computer or the like, the photosensitive drum 1 of the process cartridge PY is irradiated with laser light corresponding to the image signal from the laser scanner 7.

At this time, the surface of the photosensitive drum 1 is charged uniformly to a potential of the negative polarity in advance by the temporary collecting brush 2 and the charging roller 4, and is irradiated with the laser light from the laser scanner 7, whereby an electrostatic latent image is formed on the surface of the photosensitive drum 1. The electrostatic latent image formed on the photosensitive drum 1 is developed by the developing roller 3, so that a toner image of yellow (Y) is formed on the photosensitive drum 1.

Similarly, the photosensitive drum 1 of each of the process cartridge PM, PC, and PK is also irradiated with the laser light, so that tone images of magenta (M), cyan (C), and black (K) are formed. The toner images of the respective colors are transferred onto the intermediary transfer belt 8 by the primary transfer rollers 6Y, 6M, 6C, and 6K to which the voltage of the positive polarity is applied, and then are conveyed to a secondary transfer roller 11 by the intermediary transfer belt 8. Incidentally, an image forming process for each color is performed at a timing when an associated toner image is superposed on its upstream toner image primary transferred on the intermediary transfer belt 8.

After the toner image is primary transferred from the photosensitive drum 1 on the intermediary transfer belt 8, the surface potential of the photosensitive drum 1 is discharged (charge-removed) to about 0 [V]. This is because the surface of the photosensitive drum 1 causes potential non-uniformity due to exposure to light by the laser scanner 7 and electric discharge by the primary transfer rollers and thus is directed to obtain a uniform dark-portion potential (Vd) by uniformizing the potential non-uniformity.

The image forming apparatus 100 of this embodiment employs the cleaner-less type using a simultaneous development and cleaning type. That is, after the toner image is primarily transferred from the photosensitive drum 1 onto the intermediary transfer belt 8, primary transfer residual toner remaining on the surface of the photosensitive drum 1 is electrostatically contacted in the developing nip. Most of the primary transfer residual toner is toner of the negative polarity which is a normal charge polarity.

The primary transfer residual toner of the negative polarity on the surface of the photosensitive drum 1 remains on the surface of the photosensitive drum 1 during passing through the brush nip and the charging nip. This is because surface potentials of the temporary collecting brush 2 and the charging roller 4 are negatively higher than a surface potential of the photosensitive drum 1 (hereinafter, this surface potential is referred to as a drum (surface potential). Incidentally, the drum (surface) potential at this time is almost equal to the light-portion potential (Vl). The drum potential becomes the dark-portion potential (Vd) again during passing through the charging nip, and then in the developing nip, the primary transfer residual toner is transferred from the photosensitive drum 1 onto the developing roller 3 and is collected. This is because a potential of the developing roller 3 to which the voltage (Vdc) of the negative polarity is applied is lower than the dark-portion potential (Vd) of the photosensitive drum 1.

On the other hand, in a full-color image forming apparatus, it has been known that reverse transfer such that toner transferred on the intermediary transfer belt on an upstream side in a transfer process performed plural times is transferred onto the photosensitive drum in the transfer process on a downstream side occurs in some cases. Specifically, the reverse transfer of the toner is a phenomenon such that a polarity of the toner of the color on the upstream side on the intermediary transfer belt is reversed by the (electric) discharge generated between the photosensitive drum and the intermediary transfer belt and then the toner reversed in polarity is electrostatically reversely transferred onto the photosensitive drum on the downstream side. In the following, the toner which is reversely transferred on the photosensitive drum is referred to as reversely transferred toner.

The reversely transferred toner is toner of the positive polarity opposite to the negative polarity which is the normal (charge) polarity in this embodiment.

In this embodiment, for example, a part of the toner of yellow (Y) and a part of the toner of magenta (M) are reversely transferred onto the photosensitive drums 1 of the process cartridges PC and PK each when passes through an associated primary transfer portion between the associated one of the primary transfer rollers 6C and 6K and the photosensitive drum 1.

Most of the reversely transferred toner becomes the toner of the positive polarity by the discharge in the primary transfer portion as described above. Therefore, the reversely transferred toner is transferred and deposited on the temporary collecting brush 2 and the charging roller 4 in the case where the surface potentials of the temporary collecting brush 2 and the charging roller 4 are potentials negatively higher than the drum potential in a reverse transfer generating portion. On the other hand, the reversely transferred toner remains on the surface of the photosensitive drum 1 without being transferred onto the temporary collecting brush 2 and the charging roller 4 in the case where the surface potentials of the temporary collecting brush 2 and the charging roller 4 are potentials negatively lower than the drum potential in the reverse transfer generating portion.

Particularly, in this embodiment, the potential of the charging roller 4 becomes −1070 [V] and is always higher than the drum potential. For this reason, a constitution in which the reversely transferred toner is basically deposited on the charging roller 4 in the case where the reversely transferred toner passes through the temporary collecting brush 2 is employed. A relationship between the drum potential and the potential of the temporary collecting brush 2 in the reverse transfer generating portion will be described later.

In parallel to this image forming process, the sheet K accommodated in the cassette 13 of the sheet feeding portion 50 is conveyed to a registration roller pair 16 by the feeding/conveying device 12. A leading end of the sheet K abuts against a nip of the registration roller pair 16 in a rest state, so that oblique movement of the sheet K is corrected. The sheet K of which oblique movement is corrected by the registration roller pair 16. Then, onto the sheet K, the full-color toner image on the intermediary transfer belt 8 is transferred by a secondary transfer bias of the positive polarity applied to the secondary transfer roller 11 as a secondary transfer portion.

On the sheet K on which the toner image is transferred, the toner is melted and stuck (fixed) by imparting thereto predetermined heat and pressure by the fixing film 18 and the pressing roller 19 of the fixing device 17. The sheet K passed through the fixing device 17 is discharged onto a discharge tray 29 by a discharging roller pair 20.

Further, after the toner image is secondarily transferred from the intermediary transfer belt 8 onto the sheet K, secondary transfer residual toner which is toner remaining on the surface of the intermediary transfer belt 8 is mechanically scraped off by a cleaning blade 21 as a cleaning member. Further, the secondary transfer residual toner scraped off by the cleaning blade 21 is collected toward a residual toner collecting container 22.

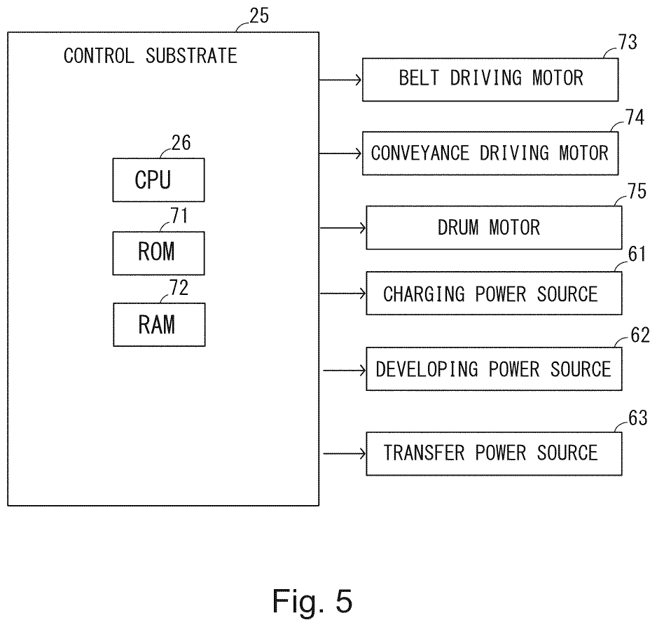

Further, the image forming apparatus 100 includes a control substrate 25 on which an electric circuit for controlling the image forming apparatus 100 is mounted. FIG. 5 is a block diagram showing control blocks of the image forming apparatus 100. As shown in FIG. 5, on the control substrate 25, a CPU (Central Processing Unit) 26 as a controller, a ROM (Read Only Memory) 71, and a RAM (Random Access Memory) 72 are mounted. In the ROM 71, various programs are stored, and the CPU 26 reads and executes the program stored in the ROM 71. The RAM 72 is used as a work area of the CPU 26.

The CPU 26 has functions of control of an intermediary transfer belt driving motor 73, a conveyance driving motor 74, and a drum motor 75, control of various image signals relating to the image formation, and the like. The intermediary transfer belt driving motor 73 is a motor for driving the intermediary transfer belt 8. The conveyance driving motor 74 is a motor for driving the feeding/conveying device 12, the registration roller pair 16, and the fixing device 17. The drum motor 75 is a driving source of the process cartridge. The CPU 26 controls applied voltages to the charging roller 4, the developing roller 3, the transfer rollers, and the like by controlling a charging power source 61, a developing power source 62, and a transfer power source 63. Further, the CPU 26 may control a voltage applied to the temporary collecting brush 2 by controlling the charging power source 61, but may also control the voltage applied to the temporary collecting brush 2 by a power source other than the charging power source 61. Incidentally, the transfer power source 63 may be divided into a plurality of primary transfer power sources for controlling applied voltages to the primary transfer rollers 6Y, 6M, 6C, and 6K, respectively, and a secondary transfer power source for controlling an applied voltage to the secondary transfer roller 11. Further, a CPU for controlling the above-described various motors and a CPU for controlling the above-described various power sources may be provided separately.

In the following, charging constitutions of embodiments 1 to 3 are described, and therefore, potential control suitable for each of the embodiments 1 to 3 will be described.

### <Embodiment 1

### (2. Manufacturing Method of Photosensitive Drum)

### (2-1. Supporting Member)

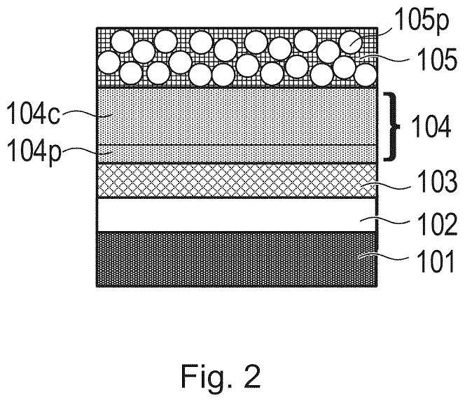

As shown in FIG. 2, a supporting member 101 for the photosensitive drum 1 is constituted, by an aluminum cylinder of 24 [mm] in diameter and 257.5 [mm] in length.

### (2-2. Electroconductive Layer)

An electroconductive layer 102 of the photosensitive drum 1 is manufactured in the following manner. That is, a dispersion including tin oxide (TiO₂) particles coated with oxygen-deficient tin oxide (SnO₂) as metal oxide particles, phenolic resin as a binder material 1, 1-methoxy-2-propanel as a solvent, silicone resin particles as a surface roughness imparting material, and silicone oil as a leveling agent was dip-coated on the supporting member 101, and was heated for 1 hour at 140° C., thus forming an electroconductive layer 102 of 30 [μm] in film thickness on the supporting member 101.

### (2-3. Undercoat Layer)

An electron transporting substance shown by a formula (E-1) below, a black isocyanate, styrene-acrylic resin, and silica slurry were dissolved in a mixed solvent of 1-butanol and acetone and was dip-coated on the electroconductive layer 102, followed by heating for 30 minutes at 170° C., so that an undercoat layer 103 of 0.7 [μm] in film thickness was formed.

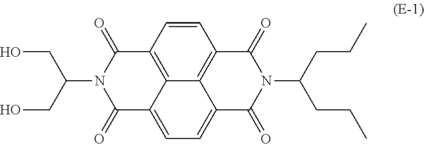 [SMILES: CCCC(CCC)N1C(=O)c2ccc3c4c(ccc(c24)C1=O)C(=O)N(C(CO)CO)C3=O]

### (2-4. Photosensitive Layer)

A photosensitive layer 104 includes a charge generating layer 104p and a charge transporting layer 104c as described above. A coating liquid obtained by diluting crystalline hydroxy gallium phthalocyanine and polyvinyl butyral resin with cyclohexane and ethyl acetate was dip-coated on the undercoat layer 103, followed by drying for 10 minutes at 95° C., so that the charge generating layer 104p of 0.20 [μm] in film thickness.

A coating liquid obtained by dissolving a charge transporting substance shown by formula (C-1) below, a charge transporting substance shown by formula (C-2) below, a charge transporting substance shown by formula (C-3) below, polycarbonate, and polycarbonate resin including copolymer units of formula (C-4) below and formula (C-5) in a mixed solvent of o-xylene, methyl benzoate, and dimethoxymethane was dip-coated on the charge generating layer 104p, thus forming a coating film, and then the coating film was dried for 30 minutes at 120° C., so that a charge transporting layer 104c of 12 [μm] in film thickness.

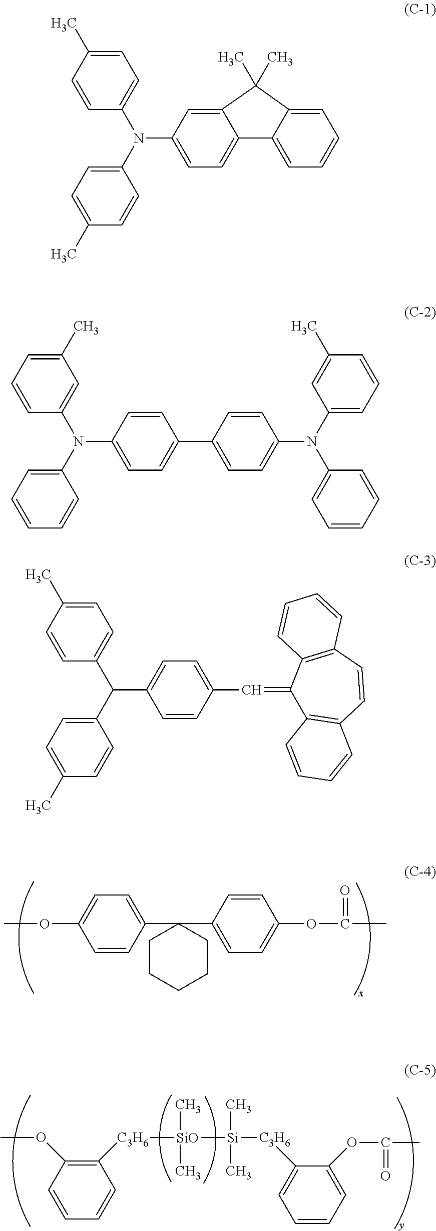

### (2-5. Outermost Surface Layer)

An outermost surface layer 105 is provided on the charge transporting layer 104c of the photosensitive layer 104 and is manufactured in the following manner. That is, a coating liquid obtained by mixing a siloxane-modified acrylic compound (trade name: “SYMAC US270”, manufactured by TOAGOSEI CO., LTD.) as a binder resin in a mixed solvent of 1-propanol and cyclohexane was dip-coated on the charge transporting layer, thus fixing a coating film, and then the coating film was dried for 5 minutes at 40° C. Thereafter, in nitrogen atmosphere, a temperature of the coating film was increased to 100° C. Then, in atmosphere, the coating film was naturally cooled until a temperature thereof becomes 25° C., followed by heating treatment for 20 minutes under a condition in which the coating film temperature becomes 100° C., so that an outermost surface layer 105 of 2 [μm] in film thickness was formed. Incidentally, in the embodiment 1, a coating liquid was prepared by mixing the following ingredients in a compounding ratio.

| | | |
|---|---|---|
| Siloxane-modified acrylic compound | 0.1 | part |
| 1-propanol | 70 | parts |
| Cyclohexane | 30 | parts |

### (3. Constitution of Temporary Collecting Brush)

The temporary collecting brush 2 in the embodiment 1 is provided downstream of the primary transfer portion and upstream of the charging nip with respect to a rotational direction. The temporary collecting brush 2 is a bar brush prepared by applying raw fabric of 5 [mm] in width, obtained by processing electroconductive nylon fibers using carbon black as an electroconductive agent into pile fabric, to a plated steel plate (metal plate) of 1 [mm] in thickness. In other words, the temporary collecting brush 2 includes a supporting member constituted from the metal plate, and a brush portion, with which the photosensitive drum 1 is rubbed, constituted by fibers mounted to the supporting member and having electroconductivity.

The electroconductive nylon fibers have fineness of 2 denier, implanting density of 240 [fibers/mm²], and a pile length of 6 [mm], and is contacted to the photosensitive drum 1 so that a penetration amount from a fur tip becomes 0.5 [mm]. The temporary collecting brush 2 has a variation in height of fur tips, and therefore, when the penetration amount thereof into the photosensitive drum 1 is excessively small, a contact state thereof with the photosensitive drum 1 becomes unstable. In this case, there is a liability that a collecting performance of the toner on the photosensitive drum 1 by the temporary collecting brush 2 becomes insufficient.

On the other hand, when the penetration amount of the temporary collecting brush 2 into the photosensitive drum 1 is excessively large, contact pressure between the temporary collecting brush 2 and the photosensitive drum 1 becomes high, so that scars or the like on the photosensitive drum 1 are generated by the temporary collecting brush 2 in some instances. Further, when the penetration amount of the temporary collecting brush 2 into the photosensitive drum 1 is excessively large, there is a liability that the transfer residual toner remaining on the surface of the photosensitive drum 1 is blocked by the temporary collecting brush 2 and an inside of the image forming apparatus 100 is contaminated with the transfer residual toner dropped in the image forming apparatus 100. Therefore, there is a need to set design values such as the implanting density, the fineness, the pile length, the penetration amount, and the like of the temporary collecting brush 2 by achieving balance from the above-described viewpoints.

In this embodiment, as the temporary collecting brush 2, a temporary collecting brush of 1×10⁵ [Ω] in resistance value was used. The resistance value is obtained by bringing the temporary collecting brush 2 into contact with a metal cylinder having the same diameter as a diameter of the photosensitive drum 1 as a substitute therefor under the same condition as a condition for the photosensitive drum 1 and then by converting a value of a current flowing through the temporary collecting brush 2 under application of a voltage of −100 V into a resistance value. Incidentally, the resistance value of the temporary collecting brush 2 can be controlled by changing a material of the electroconductive fibers of the temporary collecting brush 2, or the like.

### (4. Constitution of Charging Roller)

Further, the charging roller 4 in the embodiment 1 employs a so-called contact charging type, and spark discharge is generated by forming a potential difference exceeding a discharge threshold on the photosensitive drum 1 in the charging nip, so that the surface of the photosensitive drum 1 is charged. The charging roller 4 may desirably have a constitution in which a stable spark discharge performance can be obtained for suppressing potential non-uniformity on the surface of the photosensitive drum 1.

Therefore, in the embodiment 1, the charging roller 4 obtained by extrusion processing and having a single-layer structure consisting of an electroconductive hydrin rubber was employed. The resistance value of the charging roller 4 is about 1×10⁶ [Ω]. Similarly as the temporary collecting brush 2, the resistance value of the charging roller 4 is obtained by bringing the charging roller 4 into contact with the metal cylinder and then by converting a value of a current flowing through the charging brush 4 under application of a voltage of −100 V into a resistance value.

### Embodiment 2

Next, a constitution of a photosensitive drum 1 in an embodiment 2 will be described, but the photosensitive drum 1 in the embodiment 2 includes, similarly as in the embodiment 1, a supporting member 101, an electroconductive layer 102, an undercoat layer 103, and a photosensitive layer 104. On the other hand, the photosensitive drum 1 in the embodiment 2 is different from the photosensitive drum 1 in the embodiment 1 only in constitution of an outermost surface layer 105.

### (5. Outermost Surface Layer)

An outermost surface layer 105 as a charge injection layer in the embodiment 2 is provided on the charge transporting layer 104c of the photosensitive layer 104 and is manufactured in the following manner. That is, a coating liquid obtained by mixing a compound shown by the following structural formula (O-1) below as a binder resin and niobium-containing titanium oxide particles as electroconductive particles in a mixed solvent of 1-propanol and cyclohexane was dip-coated on the charge transporting layer 104c, thus fixing a coating film, and then the coating film was dried for 6 minutes at 50° C. Thereafter, in nitrogen atmosphere, a temperature of the coating film was increased to 117° C. Then, in atmosphere, the coating film was naturally cooled until a temperature thereof becomes 25° C., followed by heating treatment for 1 hour under a condition in which the coating film temperature becomes 120° C., so that a charge injection layer of 2 [μm] in film thickness was formed as the outermost surface layer 105.

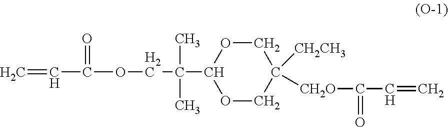

In the embodiment 2, a coating liquid dip-coated on the charge transporting layer 104c was prepared by mixing the following ingredients in the following compounding ratio, and volume resistivity of a coating film formed by the coating liquid was about 1.0×10¹³ [Ω·cm].

| | | |
|---|---|---|
| Compound shown by structural formula (O-1) | 79 | parts |
| Niobium-containing titanium oxide particles | 76 | parts |
| 1-propanol | 100 | parts |
| Cyclohexane | 100 | parts |

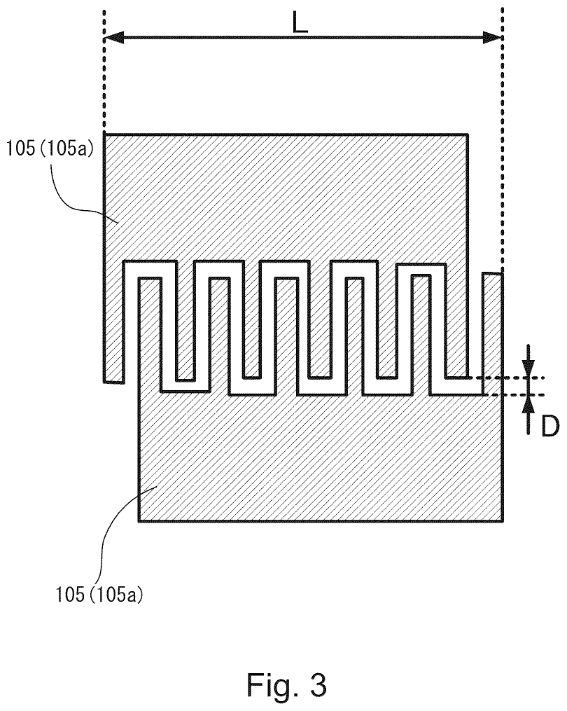

The volume resistivity of the outermost surface layer 105 can be measured by using a pA (picoampere) meter. A measuring method of the volume resistivity of the outermost surface layer 105 will be described with reference to FIG. 3. FIG. 3 is a schematic view showing a comb-type electrode 105a capable of being used when the volume resistivity of the outermost surface layer 105 is measured. Two comb-type electrodes 105a, as shown in FIG. 3, having an inter-electrode distance (D)=180 [μm] and a length (L)=59 [mm] is prepared by vapor deposition, and therein, the outermost surface layer 105 is formed. The comb-type electrodes 105a are constituted by two comb-shaped electrodes insulated from each other. In an environment of a temperature of 23° C. and a humidity of 50% RH, a DC current (I) when a DC voltage (V) of 1000 [V] is applied to between the comb-type electrodes 105a is measured, and from a ratio of (DC voltage (V))/(DC current (I), surface resistivity ρs of the outermost surface layer (charge injection layer) 105 is calculated.

By using the resultant surface resistivity ρs and a film thickness t [cm] of the outermost surface layer 105, volume resistivity ρv [Ω·cm] can be obtained by the following formula (1).

$$ρ v = ρ s \times t \qquad ( 1 )$$

(ρv: volume resistivity, ρs: surface resistivity, t: thickness of outermost surface layer)

### (6. Constitution of Temporary Collecting Brush)

It has been known that a charging property of a photosensitive drum in an injection charging type is such that a better performance can be obtained with lower resistances of a charging member and the outermost surface layer of the photosensitive drum and with a larger contact area of the charging member. In the case where an electroconductive bar brush is used as the temporary collecting brush 2, it is confirmed that an injection charge property lowers when a resistance value thereof exceeds 1.0×10⁹ [Ω]. Further, although a contact area increases with an increasing penetration amount of the temporary collecting brush 2 into the photosensitive drum 1 and thus the injection charge property is improved, there are risks such that scars can be generated on the photosensitive drum 1 and that the transfer residual toner is blocked. For this reason, it is confirmed that the penetration amount of the temporary collecting brush 2 into the photosensitive drum 1 may desirably be made about 0.5 to 1.0 [mm]. In the embodiment 2, similarly as in the embodiment 1, as the temporary collecting brush 2, a temporary collecting brush of 1×10⁵ [Ω] in resistance value was used. Further, the temporary collecting brush 2 is 240 [fibers/mm²] in implanting density and 0.5 [mm] in penetration amount of the temporary collecting brush 2 into the photosensitive drum 1, so that the contact area thereof with the photosensitive drum 1 can be sufficiently ensured and thus a good injection charge performance can be obtained.

### (7. Constitution of Charging Roller)

The charging roller 4 secondarily charges the photosensitive drum 1 by spark discharge in order to uniformize the potential non-uniformity of the photosensitive drum 1 by the temporary collecting brush 2 and to increase the drum potential to a desired dark-portion potential (Vd). That is, a charging constitution in the embodiment 2 is such that the outermost surface layer (charge injection layer) 105 of the photosensitive drum 1 is charged by combining direct charge injection from the temporary collecting brush 2 with the spark discharge by the charging roller 4. The charging roller 4 may desirably have a constitution in which the injection charge property is low and in which a stable spark discharge performance can be obtained.

In order to suppress the injection charge from the charging roller 4, a constitution in which the surface of the charging roller 4 has a high resistance and a constitution in which a contact area of the charging roller with the photosensitive drum 1 is small are effective. Therefore, in this embodiment, the charging roller 4 having a two-layer structure including a high-resistance surface layer prepared by spray-coating a coating liquid, obtained by mixing particles of about 20 [μm] in particle size in an urethane-based resin material, onto a surface of an electroconductive hydrin rubber obtained by extrusion processing was employed. The volume resistivity of the high-resistance surface layer is about 1×10¹⁴ [Ω·cm]. Further, an arithmetic average roughness Ra such that surface roughness of the high-resistance surface layer is represented by a numerical value is about 2.0 [μm]. From a viewpoint of suppressing the injection charge property, it is desirable that the volume resistivity of the high-resistance surface layer is 1×10¹² [Ω·cm] or more and that the arithmetic average roughness Ra of the high-resistance surface layer is 0.5 to 3.0 [μm].

### Embodiment 3

### (8. Pre-Exposure Device)

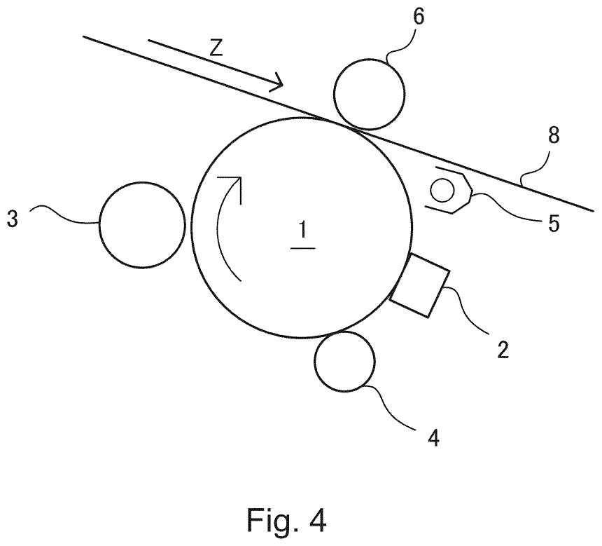

In an embodiment 3, in addition to the charging constitution of the embodiment 1, as shown in FIG. 4, a process cartridge includes a pre-exposure device 5. FIG. 4 is a schematic view showing a peripheral constitution of a photosensitive drum 1 in the embodiment 3. The pre-exposure device 5 is disposed downstream of a primary transfer portion between the photosensitive drum 1 and a primary transfer roller 6 and upstream of a temporary collecting brush 2 with respect to a rotational direction of the photosensitive drum 1. The pre-exposure device 5 electrically discharges both the dark portion Vd and the light portion Vl of the photosensitive drum 1 to 0 [V]. For this reason, in the embodiment 3, a drum potential before passing through the temporary collecting brush 2 (hereinafter, this drum potential is referred to as a pre-brush potential) becomes 0 [V] irrespective of an image pattern.

### Comparison Example

Compared with the constitution of the embodiment 1, a constitution in which the temporary collecting brush 2 is not provided was employed as a comparison example.

### (9. Pre-Brush Potential)

Next, the pre-brush potential during the image formation will be described using a table 1 below. The table 1 shows a result of measurement of the pre-brush potential while changing a print image of cyan and a print image of yellow/magenta formed upstream of the print image of a cyan in the process cartridge PC for cyan. Measurement of the pre-brush potential was performed by remodeling the process cartridge PC for cyan of the image forming apparatus 100 and by disposing a potential measuring probe (model: “3800-S2”, manufactured by Trek Japan K.K.) in a center portion with a distance of 1.0 [mm] from a drum surface with respect to a widthwise direction. Incidentally, in the constitution of the embodiment 3, the above-described potential measuring probe was disposed between the pre-exposure device 5 and the temporary collecting brush 2 and the measurement of the pre-brush potential was performed. The disposed potential measuring probe was connected to a surface potential meter (model 370, manufactured by Trek Japan K.K.), so that the surface potential of the photosensitive drum 1 was made measurable.

TABLE 1
UNIT: (V)

| PRINT IMAGE*2 | | | | | |
|---|---|---|---|---|---|
| Y/M I | FULL WHITE 0% | M HT 25% | M HT 50% | M FB 100% | YM FB 200% |

| | | | |
|---|---|---|---|
| CNS*1 | C I | FB 100% | FULL WHITE 0% |

| | | | | | | |
|---|---|---|---|---|---|---|
| EMB. 1 | −120 | −400 | −415 | −440 | −460 | −510 |
| EMB. 2 | −120 | −400 | −415 | −440 | −460 | −510 |
| EMB. 3 | 0 | 0 | 0 | 0 | 0 | 0 |
| COMP. EX. 1 | −120 | −400 | −415 | −440 | −460 | −510 |

*1“CNS” is constitution.
*2“Y/M I” is yellow/magent image. “C I” is cyan image. “FB” is full black. “M” is magenta. “HT” is half-tone. “YM” is yellow/magenta.

As shown in the table 1, in each of the embodiments 1 and 2 and the comparison example, the pre-brush potential is different depending on the print image of cyan which is the color of the toner for the process cartridge PC subjected to the potential measurement and on the print image of yellow/magenta on the side upstream of the print image of cyan. Further, in the embodiment 3, by a discharging effect (charge-removing effect) of the pre-exposure device 5, for each of the print images (image patterns), the pre-brush potential of the photosensitive drum 1 of the process cartridge PC (hereinafter, this pre-brush potential is simply referred to as the pre-brush potential) was 0 [V]. In the following, a difference in pre-brush potential between the embodiments 1 and 2 and the comparison example will be described.

In the case where the print image of yellow/magenta is full white, i.e., a print ratio is 0% and thus printing is not made and where the print image of cyan is full black, i.e., the print ratio is 100%, in either of the embodiments 1 and 2 and the comparison example, the pre-brush potential was −120 [V] and was equal to the light-portion potential (Vl). The print ratio of 0% is a state in which the image is not formed at all on the sheet K or in an image forming region, and the print ratio of 100% is a state in which a solid black image is formed on the whole sheet K or in the whole image forming region, i.e., the sheet K or the image forming region is blackened completely.

On the other hand, in the case where the print image of yellow/magenta and the print image of cyan are full white, in either of the embodiments 1 and 2 are the comparison example, the pre-brush potential was −400 [V] and was lower than the dark-portion potential (Vd)=−520 [V]. Incidentally, in the description of this embodiment, high/low of the potential is described as high/low in the case where the potentials were compared with each other in terms of an absolute value. This would be considered because a potential difference between the dark-portion potential (Vd) and the surface of the intermediary transfer belt 8 is a discharge threshold and the drum potential after the primary transfer is lowered by the discharge.

Incidentally, it is confirmed that the discharge is started in the primary transfer portion at the time when a potential difference between the surface of the intermediary transfer belt 8 and the photosensitive drum 1C (see FIG. 1) on which the toner image of cyan is formed is 550 [V] or more and when a potential difference between the applied voltage to the primary transfer roller 6C and the photosensitive drum 1C is 640 [V] or more. In the constitution of this embodiment, the dark-portion potential (Vd) is −520 [V] and the transfer voltage of the primary transfer roller 6C is +300 V, so that a potential difference of 820 V is formed in the primary transfer portion. Therefore, in the case where the print image of yellow/magenta and the print image of cyan and full white, the potential difference in the primary transfer portion is the discharge threshold or more, and therefore, it would be considered that the discharge is generated in the neighborhood of the primary transfer portion.

On the other hand, the light-portion potential (Vl) is −120 V, and therefore, in the case where the print image of yellow/magenta is full white and the print image of cyan is full black, the potential difference in the primary transfer portion is 420 [V] and is below the discharge threshold, and therefore, it would be considered that the drum potential after the primary transfer is not changed from the light-portion potential (Vl).

Next, in the case where the print image of cyan is full white and the print image of yellow/magenta is colors other than full white, in either case of the embodiments 1 and 2 and the comparison example, the pre-brush potential was a potential higher than −400 [V]. Further, there was a tendency that the pre-brush potential became higher with a higher print ratio for yellow/magenta. Specifically, the pre-brush potential became higher in an order of an entire surface half-tone image of magenta with a print ratio of 25% (M half-tone 25%) an entire surface half-tone image of magenta with a print ratio of 50% (M half-tone 50%), an entire painted-out image of magenta with a print ratio of 100% (M full-black 10%), and an image formed by superposing entire painted-out images of magenta and yellow with a print ratio of 100% (YM full-black 200%). For the print image of YM full-black 200%, the pre-brush potential was −510 [V] which is a high voltage close to the dark-portion potential (Vd). This would be considered because the toner images of yellow and magenta having the negative polarity are superposed on the surface of the intermediary transfer belt 8 and a substantial surface potential of the intermediary transfer belt 8 becomes high on the negative side, and thus the potential difference between the dark-portion potential (Vd) and the surface is reduced. Particularly, it would be considered that the potential difference is reduced to a level of less generation of the discharge in the case where both the print images of yellow and magenta are formed as full black images.

As described above, the pre-brush potential is changed by not only the print image of the associated color (cyan in the above-described example) in the image formation but also the print images of colors (yellow and magenta in the above-described example) on the side upstream of the print image of the cyan. Particularly, it can be said that the case of a print image high in pre-brush potential is the case where a toner amount of the print image of the color on the upstream side is large and the color in the image formation is full white. Further, for various print images, in order to satisfactorily collect the reversely transferred toner the upstream(-side) color by the temporary collecting brush 2, there is a need to appropriately select the potential of the temporary collecting brush 2.

In the following, in the constitutions of the embodiments 1 to 3 and the comparison example, a result of confirmation of occurrence/non-occurrence of a charging ghost and a reversely transferred toner collecting performance when the potential of the temporary collecting brush 2 is changed from −100 [V] to −1200 [V] will be described. In addition, an appropriate potential of the temporary collecting brush 2 will be described. Incidentally, the charging ghost is an image defect due to deposition of the reversely transferred toner on the charging member (charging roller 4). When toner in a large amount is deposited on the surface of the charging member (charging roller 4), a charging performance is changed and the drum potential is deviated from a desired drum potential, so that an image density becomes thinner or thicker than an original image density in some instances. Particularly, when the reversely transferred toner is concentratedly deposited on the same portion, the image density is changed only in the deposited portion.

### (10-1. Evaluation Method)

Effects of the constitutions of the embodiments 1 to 3 were confirmed by checking a toner accumulation amount of each of the temporary collecting brush 2 and the charging roller 4 and by checking the occurrence/non-occurrence of the charging ghost. Evaluation was performed under an evaluation condition such that in an environment of 23° C. in temperature and 50% RH in humidity, images each including three vertical bands each of 40 [mm] in width and 200 [mm] in length in one page were continuously printed on 59 pages and thereafter an entire surface half-tone image of cyan with a print ratio of 25% (C 25% half-tone) was printed on one page. The three vertical bands were an image obtained by superposing entire surface painted-out images of magenta and yellow with a print ratio of 100% (YM full black), an entire surface painted-out image of magenta with a print ratio of 100% (M full black), and an entire surface half-tone image of magenta with a print ratio of 50% (M 50% half-tone), respectively, and were the images liable to be reversely transferred.

Further, as a recording material, A4-size paper (“GF-C081”, manufactured by Canon K.K.) was used. In the constitutions of the embodiments 1 to 3 and the comparison example, evaluation was performed while changing the potential of the temporary collecting brush 2 in a range from −100 [V] to −1200 [V] with an increment (step) of 100 [V], so that the evaluation was performed in a potential setting of 12 patterns for one constitution. Incidentally, for each evaluation of one setting, the surface of the temporary collecting brush 2 and the surface of the charging roller 4 were cleaned.

Discrimination of the charging ghost was made such that a density difference of the half-tone image in each vertical band portion in the entire surface half-tone image of cyan with the print ratio of 25% on 60-th page is checked, and a constitution in which the density difference is slight and is allowable was evaluated as “◯”, and a constitution in which the density difference is large and is unallowable was evaluated as “×”. In a table 2 appearing hereinafter, the three vertical band portions are shown as a YM full-black portion, an M full-black portion, and an M50% half-tone portion, and pre-brush potentials corresponding to the respective vertical band portions after the primary transfer are also shown in the table 2.

The reversely transferred toner collecting performance of the temporary collecting brush 2 was evaluated by disassembling the process cartridge PC after continuous printing for 60 pages and then by checking outer appearances of the temporary collecting brush 2 and the charging roller 4 in a collecting state of the reversely transferred toner by the temporary collecting brush 2 and in a deposition state of the reversely transferred toner on the charging roller 4. In the collection state of the reversely transferred toner by the temporary collecting brush 2 (brush collection state), a constitution in which a reversely transferred toner collection amount is large was evaluated as “◯”, and a constitution in which the reversely transferred toner cannot be mostly collected was evaluated as “x”. In the deposition state of the reversely transferred toner on the charging roller 4 (charging roller deposition state), a state in which deposition of the reversely transferred toner is not mostly observed was evaluated as “◯”, and a state in which the reversely transferred toner is deposited in a large amount was evaluated as “x”.

### (10-2. Evaluation Result)

From evaluation of combinations the constitutions of the embodiments 1 to 3 and the comparison example with the potentials of the temporary collecting brush 2, an evaluation result of the charging ghost is shown in the table 2 below, and an evaluation result of both the collection state of the reversely transferred toner by the temporary collecting brush 2 and the deposition state of the reversely transferred toner on the charging roller 4 is collectively shown in a table 3 below.

TABLE 2
UNIT: (V)

| | | | TEMPORARY COLLECTING BRUSH POTENTIAL | | | | | | | | | | | |
|---|---|---|---|---|---|---|---|---|---|---|---|---|---|---|
| CNS*1 | PBP*2 | | −100 | −200 | −300 | −400 | −500 | −600 | −700 | −800 | −900 | −1000 | −1100 | −1200 |
| EMB. 1 | YMFBP | −510 | X | X | X | X | X | ◯ | ◯ | ◯ | ◯ | ◯ | ◯ | ◯ |
| | MFBP | −460 | X | X | X | X | ◯ | ◯ | ◯ | ◯ | ◯ | ◯ | ◯ | ◯ |
| | M50% HTP | −440 | X | X | X | X | ◯ | ◯ | ◯ | ◯ | ◯ | ◯ | ◯ | ◯ |
| EMB. 2 | YMFBP | −510 | X | X | X | X | X | ◯ | ◯ | ◯ | ◯ | ◯ | ◯ | ◯ |
| | MFBP | −460 | X | X | X | X | ◯ | ◯ | ◯ | ◯ | ◯ | ◯ | ◯ | ◯ |
| | M50% HTP | −440 | X | X | X | X | ◯ | ◯ | ◯ | ◯ | ◯ | ◯ | ◯ | ◯ |
| EMB. 3 | YMFBP | 0 | ◯ | ◯ | ◯ | ◯ | ◯ | ◯ | ◯ | ◯ | ◯ | ◯ | ◯ | ◯ |
| | MFBP | 0 | ◯ | ◯ | ◯ | ◯ | ◯ | ◯ | ◯ | ◯ | ◯ | ◯ | ◯ | ◯ |
| | M50% HTP | 0 | ◯ | ◯ | ◯ | ◯ | ◯ | ◯ | ◯ | ◯ | ◯ | ◯ | ◯ | ◯ |

| | | | |
|---|---|---|---|
| COMP. | YMFBP | −510 | X |
| EX. 1 | MFBP | −460 | X |
| | M50% HTP | −440 | X |

*1“CNS” is constitution.
*2“PBP” is pre-brush potetial. “YMFBP” is YM full-black portion. “MFBP” is M full-black portion. “M50% HTP” is M50% half-tone portion.

TABLE 3

| | | TEMPORARY COLLECTING BRUSH POTENTIAL (V) | | | | | | | | | | | |
|---|---|---|---|---|---|---|---|---|---|---|---|---|---|
| CNS*1 | MS*2 | −100 | −200 | −300 | −400 | −500 | −600 | −700 | −800 | −900 | −1000 | −1100 | −1200 |
| EMB. 1 | BCSYMFBP | X | X | X | X | X | ◯ | ◯ | ◯ | ◯ | ◯ | X | X |
| | BCSM50% HTP | X | X | X | X | ◯ | ◯ | ◯ | ◯ | ◯ | X | X | X |
| | CRDSYMFBP | X | X | X | X | X | ◯ | ◯ | ◯ | ◯ | ◯ | ◯ | ◯ |
| | CRDSM50% HTP | X | X | X | X | ◯ | ◯ | ◯ | ◯ | ◯ | ◯ | ◯ | ◯ |
| EMB. 2 | BCSYMFBP | X | X | X | X | X | ◯ | ◯ | ◯ | ◯ | X | X | X |
| | BCSM50% HTP | X | X | X | X | ◯ | ◯ | ◯ | ◯ | X | X | X | X |
| | CRDSYMFBP | X | X | X | X | X | ◯ | ◯ | ◯ | ◯ | ◯ | ◯ | ◯ |
| | CRDSM50% HTP | X | X | X | X | ◯ | ◯ | ◯ | ◯ | ◯ | ◯ | ◯ | ◯ |
| EMB. 3 | BCSYMFBP | ◯ | ◯ | ◯ | ◯ | ◯ | X | X | X | X | X | X | X |
| | BCSM50% HTP | ◯ | ◯ | ◯ | ◯ | ◯ | X | X | X | X | X | X | X |
| | CRDSYMFBP | ◯ | ◯ | ◯ | ◯ | ◯ | ◯ | ◯ | ◯ | ◯ | ◯ | ◯ | ◯ |
| | CRDSM50% HTP | ◯ | ◯ | ◯ | ◯ | ◯ | ◯ | ◯ | ◯ | ◯ | ◯ | ◯ | ◯ |

| | | |
|---|---|---|
| COMP. | CRDSYMFBP | X |
| EX. 1 | CRDSM50% HTP | X |

*1“CNS” is constitution.
*2“MS” is member status.
“BCSYMFBP” is brush collecting state: YM full-black portion.
“BCSM50% HTP” is brush collecting state: M50% half-tone portion.
“CRDSYMFBP” is charging roller deposition state: YM full-black state.
“CRDSM50% HTP” is charging roller deposition state: M50% half-tone portion.

### (10-3. Evaluation Result of Embodiment 1)

From the result shown in the table 2, it was able to be confirmed that in the constitution of the embodiment 1, the charging ghost is capable of being suppressed in either of the print images by making the potential of the temporary collecting brush 2 (hereinafter, simply referred to as a temporary collecting brush potential in some instances) not less than −600 [V]. Further, in the YM full-black portion, the potential of the temporary collecting brush 2 is required to be −600 [V], but in the M full-black portion and the M 50% half-tone portion, the charging ghost disappears at −500 [V] which is the potential of the temporary collecting brush 2. Thus, it was able to be confirmed that an appropriate potential of the temporary collecting brush 2 capable of suppressing the charging ghost is different depending on the print image of each color.

Specifically, in the YM full-black-portion in which the pre-brush potential becomes −510 [V], the potential of the temporary collecting brush 2 may preferably be −600 [V] or more. In the M full-black portion in which the pre-brush potential becomes −460 [V], the potential of the temporary collecting brush 2 may preferably be −500 [V] or more. In the M50% half-tone portion in which the pre-brush potential becomes −440 [V], the potential of the temporary collecting brush 2 may preferably be −500 [V] or more. Incidentally, as described above, high/low of the potential is described as high/low in the case where the potentials are compared with each other in terms of absolute values thereof. That is, in the following, when a magnitude relationship of the potentials is represented by an inequality sign, the magnitude relationship is shown by an inequality held in terms of absolute values of these potentials. In either of the print images, a constitution in which the evaluation of the charging ghost becomes good is a constitution in which a relationship of (pre-brush potential)<(temporary collecting brush potential) is satisfied, and it was able to be confirmed that the occurrence of the charging ghost can be suppressed by satisfying the relationship of (pre-brush potential)<(temporary collecting brush potential).

From the result shown in the table 3, in the constitution of the embodiment 1, as regards the collection state of the reversely transferred toner by the temporary collecting brush 2, it was also to be confirmed that the reversely transferred toner can be satisfactorily collected at the temporary collecting brush potential of −600 [V] to −1000 [V] in the YM full-black portion and of −500 [V] to −900 [V] in the M50% half-tone portion. Further, as regards the deposition state of the reversely transferred toner on the charging roller 4, the deposition of the reversely transferred toner was able to be suppressed at the temporary collecting brush potential of −600 [V] or more in the YM full-black portion and of −500 [V] or more in the M50% half-tone portion.

There was a tendency such that behavior when the potential of the temporary collecting brush 2 is made a high potential is different between the deposition state of the charging roller 4 and the collection state of the temporary collecting brush 2 and that as regards the collection state of the temporary collecting brush 2, the reversely transferred toner collecting property lowers when the potential of the temporary collecting brush 2 is excessively high. This would be considered because relative to the pre-brush potential, the temporary collecting brush potential becomes a potential exceeding the discharge threshold and therefore the discharge generates on the reversely transferred toner on the upstream side of the temporary collecting brush 2 and thus the polarity of the reversely transferred toner is reversed to the negative polarity. Incidentally, it is confirmed that in the brush nip between the photosensitive drum 1 and the temporary collecting brush 2, discharge is started when the potential difference between the temporary collecting brush 2 and the photosensitive drum 1 is 550 [V] or more, similarly as in the primary transfer portion.

Thereafter, it would be considered that in the constitution in which the temporary collecting brush potential is higher than the pre-brush potential by 550 [V] or more, the polarity of the reversely transferred toner is reversed to the negative polarity by the discharge and the reversely transferred toner of the negative polarity cannot be collected by the temporary collecting brush 2 having a potential negatively higher than the potential of the photosensitive drum 1. On the other hand, the reversely transferred toner of the negative polarity is collected by the developing roller 3 after passing through the charging roller 4 having a negatively high potential. For this reason, it would be considered that even when the temporary collecting brush potential is made an excessively high potential, the deposition state of the reversely transferred toner on the charging roller 4 is kept good, and the occurrence of the charging ghost is suppressed. On the other hand, the reversely transferred toner collected by the developing roller 3 is the toner of the upstream color, and therefore, there is a risk that when the electrostatic latent image is developed again by the process cartridge PC, a change in color (tint) by color mixing becomes problematic. For this reason, it is not preferable that the reversely transferred toner is collected by the developing roller 3 (developing portion).

### (10-4. Evaluation Result of Embodiment 2)

From the result shown in the table 2, also in the constitution of the embodiment 2, similarly as in the embodiment 1, it was able to be confirmed that the charging ghost can be suppressed by making the temporary collecting brush potential not less than −600 [V] in the YM full-black portion and not less than −500 [V] in each of the M full-black portion and the M50% half-tone portion. That is, also in the constitution of the embodiment 2, similarly as in the embodiment 1, it was able to be confirmed that the occurrence of the charging ghost can be suppressed by satisfying (pre-brush potential)<(temporary collecting brush potential).

From the result shown in the table 3, in the constitution of the embodiment 2, as regards the collection state of the reversely transferred toner by the temporary collecting brush 2, it was also to be confirmed that the reversely transferred toner can be satisfactorily collected at the temporary collecting brush potential of −600 [V] to −900 [V] in the YM full-black portion and of −500 [V] to −800 [V] in the M50% half-tone portion. Further, as regards the deposition state of the reversely transferred toner on the charging roller 4, the deposition of the reversely transferred toner was able to be suppressed at the temporary collecting brush potential of −600 [V] or more in the YM full-black portion and of −500 [V] or more in the M50% half-tone portion.

Different from the embodiment 1 in collecting property in the case where the temporary collecting brush potential is excessively high, in the embodiment 2, there was a tendency that even at a lower temporary collecting brush potential, the collecting property of the reversely transferred toner by the temporary collecting brush 2 lowers. This would be considered because the injection charging from the temporary collecting brush 2 into the outermost surface layer 5 of the photosensitive drum 1 is performed and therefore the charge is injected into the reversely transferred toner. It would be considered that when the temporary collecting brush potential becomes high, the charge injection amount for the reversely transferred toner is also increased and the polarity of the reversely transferred toner is reversed to the negative polarity even in a state in which the potential difference between the pre-brush potential and the temporary collecting brush potential is lower than the discharge threshold. Similarly as in the embodiment 1, the reversely transferred toner of which polarity is reversed to the negative polarity cannot collected by the temporary collecting brush 2 and is collected by the developing roller 3 after passing through the charging roller 4. For this reason, it would be considered that even when the temporary collecting brush potential is made an excessively high potential, the deposition state of the reversely transferred toner on the charging roller is kept good, and thus the occurrence of the charging ghost is suppressed.

### (10-5. Evaluation Result of Embodiment 3)

From the result shown in the table 2, in the constitution of the embodiment 3, in either of the print images, it was able to be confirmed that the charging ghost can be suppressed by making the temporary collecting brush potential not less than −100 [V]. It would be considered that in the constitution of the embodiment 3, the pre-brush potential becomes 0 [V] by the discharging effect of the pre-exposure device 4, and, therefore, even in either of the print images, the charging ghost was able to be suppressed at a low potential. That is, also in the constitution of the embodiment 3 similarly as in the embodiments 1 and 2, it was able to be confirmed that the occurrence of the charging ghost can be suppressed by satisfying (pre-brush potential)<(temporary collecting brush potential).

From the result shown in the table 3, as regards the collection state of the reversely transferred toner by the temporary collecting brush 2, in either of the print images, the temporary collecting brush potential is good in a range of −100 [V] to −500 [V], and when the temporary collecting brush potential is −600 [V] or more, the reversely transferred toner was not able to be collected. Further, the deposition state of the reversely transferred toner on the charging roller 4 is good at either temporary collecting brush potential of −100 [V] or more, and the deposition of the reversely transferred toner was able to be suppressed. The reason why the collecting property of the reversely transferred toner by the temporary collecting brush 2 is worsened at −600 [V] or more would be considered because the pre-brush potential is 0 [V] in the constitution of the embodiment 3, and therefore, even at a low temporary collecting brush potential, the temporary collecting brush potential exceeded the discharge threshold. Similarly as in the embodiment 1, it would be considered that the polarity of the reversely transferred toner is reversed to the negative polarity by the discharge, and the reversely transferred toner of which polarity is reversed to the negative polarity cannot collected by the temporary collecting brush 2 and is collected by the developing roller 3 after passing through the charging roller 4. For this reason, it would be considered that even when the temporary collecting brush potential is made an excessively high potential, the deposition state of the reversely transferred toner on the charging roller is kept good, and thus the occurrence of the charging ghost is suppressed.

### (10-6. Evaluation Result of Comparison Example)

From the result shown in the table 2, in the constitution of the comparison example, the charging ghost occurred in either of the print images. Further, from the result shown in the table 3, the reversely transferred toner in a large amount was deposited on the charging roller 4 for either of the print images.

### (11. Summary of Evaluation Result)

From the evaluation results of the embodiments 1 to 3 and the comparison example, it was able to be confirmed that the occurrence of the charging ghost can be suppressed by providing the temporary collecting brush 2 for collecting the reversely transferred toner on a side downstream of the primary transfer portion and upstream of the charging roller 4 with respect to the rotational direction of the photosensitive drum 1 and by satisfying (pre-brush potential)<(temporary collecting brush potential) during the image formation. That is, by satisfying (pre-brush potential)<(temporary collecting brush potential) during the image formation, the reversely transferred toner can be collected by the temporary collecting brush 2. By this, the deposition of the reversely transferred toner on the charging roller 4 is suppressed, so that the image defect such as the charging ghost by which the charging performance is changed only in a portion where the reversely transferred toner is deposited on the charging roller 4 and thus the image density is changed.

Further, in the above-described constitutions, effects were shown for the three print images, but in an actual image forming apparatus, various image patterns capable of being reversely transferred are assumed, and in that case, there is a need to satisfy (pre-brush potential)<(temporary collecting brush potential). The case of the print image for which the pre-brush potential becomes high is the case where the toner amount of the toner image of the upstream color is large and the toner image of the color for the image formation is the full-white image, and in the full-color image formation, is the case where toner images of upstream colors corresponding to three colors at the maximum are formed on the intermediary transfer belt 8.

In the image forming apparatus 100 in the above-described constitution, a full-black image of yellow, magenta, and cyan was formed on the intermediary transfer belt 8 and the pre-brush potential was measured on the process cartridge PK for black. As a result, the pre-brush potential was about −520 [V] and was substantially equal to the dark-portion potential (Vd). Therefore, the potential of the temporary collecting brush 2 may desirably be a potential higher than the dark-portion potential (Vd) from a viewpoint of the reversely transferred toner collecting property.

Further, from the evaluation results of the embodiments 1 and 3, it was able to be confirmed that a good reversely transferred toner collecting property can be obtained by making the potential difference between the temporary collecting brush potential and the pre-brush potential less than the discharge threshold. Even when the potential difference is made not less than the discharge threshold, the reversely transferred toner passed through the temporary collecting brush 2 is collected by the during roller 3, so that the charging ghost is suppressed. However, for example, when in the process cartridge PC for cyan, toner of other colors such as yellow, magenta, or the like is collected and the electrostatic latent image is developed by the process cartridge PC for cyan again, there is a risk such that a change in color (tint) due to color mixing becomes problematic. For this reason, from a viewpoint of suppressing the image defect, it is not preferable that the reversely transferred toner is collected by the developing roller 3 (developing portion).

Therefore, it is desirable that from the viewpoint of suppressing discharge for the reversely transferred toner, the potential of the temporary collecting brush 2 is less than the discharge threshold relative to the pre-brush potential for either of the print image for which the reverse transfer is capable of occurring. In the constitution of this embodiment, a change in collecting property for the three print images was shown but in the actual image forming apparatus, various image patterns capable of being reversely transferred are assumed, and in that case, there is a need that the potential difference between the pre-brush potential and the temporary collecting brush potential is less than the discharge threshold. The case of the print image for which the pre-brush potential becomes low is the case of the full-black image, i.e., the case where the pre-brush potential, becomes the light-portion potential (Vl), but as described above, at the light-portion potential (Vl), the discharge does not readily occur, and therefore, the reverse transfer hardly occurs. Therefore, the case of the print image for which the pre-brush potential becomes low under a condition in which the reverse transfer is capable of occurring is a case of a full-white image which is small in toner amount of the toner of the upstream color and for which the toner of the color for the image formation is not exposed, and the pre-brush potential in that case is almost equal to a post-transfer potential of the dark-portion potential (Vd). Therefore, from the viewpoint of suppressing the discharge for the reversely transferred toner, the potential of the temporary collecting brush 2 may desirably be less than the discharge threshold relative to the post-transfer potential after the dark portion Vd passes through the primary transfer portion.

Incidentally, when the drum potential is measured in the case where the image of the color for the image formation is a half-tone image, a potential higher than the light-portion potential (Vl) and lower than the dark-portion potential (Vd) is measured, so that the potential is capable of becoming a potential at which the discharge is generated in the primary transfer portion, and therefore, it seems that the drum potential may desirably be less than the discharge threshold relative to the post-transfer potential of the half-tone image. However, the drum potential of the half-tone image measured by a surface potential meter is a result of measurement thereof after being averaged because a spot diameter is larger than a half-tone dot diameter, and in actuality, the drum potential is almost light-portion potential (Vl) in a portion where dots are exposed and is the dark-portion potential (Vd) in a non-exposure portion. Therefore, a portion where the discharge is generated in the primary transfer portion is the dark portion Vd (non-exposure portion) of the half-tone portion, and as described above, by making the potential of the temporary collecting brush 2 less than the discharge threshold relative to the post-transfer potential of the dark portion Vd, the discharge for the reversely transferred toner can be suppressed.

From the evaluation result of the embodiment 2, it was able to be confirmed that in a constitution in which the temporary collecting brush 2 also has a function as an injection charging member, a good reversely transferred toner collecting property can be obtained by setting the potential of the temporary collecting brush 2 so as to provide a potential difference, between itself and the pre-brush potential, of less than the discharge threshold and so as to be lower than the pre-brush potential by about 10 [V]. The charge injection amount to the reversely transferred toner changes depending on constitution of the temporary collecting brush 2 and the outermost surface layer 105 of the photosensitive drum 1, or the like, but it is confirmed that a tendency thereof becomes more conspicuous with higher electroconductivity of each constitution.

It is confirmed that when the resistance value of the temporary collecting brush 2 exceeds 1.0×10⁹ [Ω], an injection charging property to the reversely transferred toner is also lowered similarly as an injection charging property to the reversely transferred toner is also lowered similarly as an injection charging property to the photosensitive drum 1.

Further, it is confirmed that when the volume resistivity of the outermost surface layer 105 of the photosensitive drum 1 exceeds 1.0×10¹⁴ [Ω·cm], the injection charge property to each of the photosensitive drum 1 and the reversely transferred toner lowers. On the other hand, when the volume resistivity of the outermost surface layer 105 is less than 1.0×10⁹ [Ω·cm], there is a tendency that it becomes hard to retain the latent image and thus a print quality of a thin line lowers. In a combination between lower limits of the volume resistivity of the photosensitive drum 1 and the resistance of the temporary collecting brush 2, usable from a viewpoint of the print quality, it is known that the potential difference, between the pre-brush potential and the potential of the temporary collecting brush 2, by which the reversely transferred toner collecting property is lowered by injecting electric charges to the toner is 350 [V] or more. Therefore, as in the embodiment 2, in the constitution in which the temporary collecting brush 2 also has the function as the injection charge member, from the viewpoint of suppressing the discharge to the reversely transferred toner, it is more desirable that the temporary collecting brush potential is less than 350 [V] relative to the post-transfer potential after the dark portion Vd (non-exposure portion) passes through the primary transfer portion.

### (12. Conclusion)

As described above, in each of the embodiments 1 to 3, the temporary collecting brush 2 was provided as the collecting member disposed on a side downstream of the primary transfer roller (transfer portion) and upstream of the charging roller 4 with respect to the rotational direction of the photosensitive drum 1. The temporary collecting brush 2 is capable of electrostatically collecting the reversely transferred toner. Incidentally, in the image forming apparatus 100 in which a first toner image having a first color (for example, yellow or magenta) is formed and then a second toner image having a second color (for example, cyan) different from the first color is transferred onto the intermediary transfer belt 8 so as to be superposed on the first toner image, the temporary collecting brush 2 of the process cartridge (PC) for forming the toner image of the second color electrostatically collects the reversely transferred toner of the first color.

In such an image forming apparatus 100, an absolute value of the potential of the temporary collecting brush 2 during the image formation is defined as V1, and an absolute value of the surface potential (drum potential) of the photosensitive drum 1 before an associated potential of the photosensitive drum 1 passes through the temporary collecting brush 2 is defined as V2. At this time, the CPU 26 controls voltages applied to the charging roller 4 and the temporary collecting brush 2 so that V2<V1 is satisfied and so that (V1−V2) becomes less than the discharge threshold. For example, in the embodiments 1 and 2, as shown in the tables 2 and 3, V1 may preferably be set to −600 [V] to −900 [V]. Further, in the embodiment 3, as shown in the tables 2 and 3, V1 may preferably be set to −100 [V] to −500 [V]. By this, it is possible to suppress the image defect such as the charging ghost or the change in color (tint) due to the color mixing.

Further, in the above-described embodiments, during the image formation, the reversely transferred toner is collected by the temporary collecting brush 2, so that there is no need to perform another processing such as a cleaning operation after an end of the image forming operation.

Therefore, an increase in downtime of the image forming apparatus 100 is suppressed, and throughput can be improved.

Further, an absolute value of the drum potential immediately after passing through the charging roller 4 during the image formation is defined as V3, and an absolute value of the surface potential of the photosensitive drum 1 in the non-exposure portion (dark portion Vd) after passing through the primary transfer portion and before passing through the temporary collecting brush 2 is defined as V4. At this time, the CPU 26 controls voltages applied to the charging roller 4 and the temporary collecting brush 2 so that V3<V1 is satisfied and so that (V1−V4) becomes less than the discharge threshold. By this, even in a print image pattern, for which the pre-brush potential becomes highest, such that a full-block image of yellow, magenta, and cyan is formed on the intermediary transfer belt 8 and a full-white image is formed in the process cartridge PK for black, it is possible to suppress the image defect such as the charging ghost or the change in color (tint) due to the color mixing.

Further, as in the embodiment 2, in a constitution in which the outermost surface layer 105 which is the charge injection layer of the photosensitive drum 1 is charged by combining direct charge injection from the temporary collecting brush 2 with the spark discharge by the charging roller 4, (V1 0 V4) may preferably become less than 350 [V]. This is because by making (V1−V4) less than 350 [V], the discharge to the reversely transferred toner in the primary transfer portion is suppressed and the reversely transferred toner collecting property by the temporary collecting brush 2 is improved.

Further, a drum potential immediately after passing through the charging roller 4 during the image formation, i.e., a drum potential in the non-exposure portion (dark portion Vd) is defined as V5, a drum potential in an exposed state, i.e., a drum potential in the exposure portion (light portion Vl) is defined as V6, and a voltage applied to the primary transfer roller is defined as V7. At this time, the CPU 26 in each of the above-described embodiments controls a voltage applied to the charging roller 4 so that an absolute value of (V5−V7) is the discharge through or more and so that an absolute value of (V6−V7) is the discharge through or more. For example, in each of the above-described embodiments, V5=−520 [V], V6=−120 [V], and V7=+300 [V], and the voltage applied to the charging roller 4 is −1070 [V]. Further, the discharge is generated when the potential difference between the applied voltage to the primary transfer roller and the potential of the photosensitive drum 1 is 640 [V] or more. By such a potential relationship, in the case where the print image of the color (in the above-described embodiment, cyan) for the image formation is full-white 100% (see, the table 1), the toner is reversely transferred onto the photosensitive drum 1 due to the discharge in some instances, but by appropriately setting the potential of the temporary collecting brush 2 as shown in the tables 2 and 3, it is possible to suppress the image defect such as the charging ghost or the charge in color (tint) due to the color mixing.

### OTHER EMBODIMENTS

Incidentally, in the above-described embodiments, the full-color image forming apparatus 100 in which the image formation is performed by using the four process cartridges including four color toners was used, but the present disclosure is not limited thereto.

For example, an image forming apparatus of a direct transfer type in which toner images of the respective colors are directly transferred onto the recording material (sheet) may be used. In the direct transfer type, discharge in the transfer portion is generated between the surface of the recording material and the photosensitive drum 1. Further, it is confirmed that the discharge starts when the potential difference between the potential of the surface of the recording material and the potential of the photosensitive drum 1 is 550 [V] or more, and that the discharge is generated when a potential difference between the voltage applied to the transfer roller and the potential of the photosensitive drum 1 is higher than 640 [V] or more correspondingly that a divided voltage of the recording material is generated.

On the other hand, although a discharge position is changed from the surface of the intermediary transfer belt 8 to the surface of the recording material, there is no change in that the post-transfer potential is changed due to the discharge and that the reverse transfer occurs. Therefore, also in the full-color image forming apparatus of the direct transfer type, by satisfying a relationship between the pre-brush potential and the temporary collecting brush potential in the constitution of this embodiment, it is possible to obtain a good reversely transferred toner collecting performance by the temporary collecting brush 2 and a charging ghost suppressing effect.

Further, in the constitutions of the above-described embodiments, a tandem type in which a single photosensitive drum 1 is provided for each of the four colors of yellow, magenta, cyan, and black was employed, but a full-color image forming apparatus of a rotary type in which developing devices for four colors are provided to a single photosensitive drum 1 may be used. In the rotary type, development of the electrostatic latent image on the photosensitive drum 1 by the developing device and the primary transfer of the toner onto the intermediary transfer belt are repeated correspondingly to the four colors, so that the photosensitive drum 1 passes through the primary transfer portion four times until a full-color image is formed on the recording material. Although only one primary transfer portion is provided in the image forming apparatus of the rotary type, the potential difference in the primary transfer portion and the discharge phenomenon are similar to those in the image forming apparatuses of the constitutions of the above-described embodiments. That is, the toner image of the upstream color on the intermediary transfer belt is capable of being reversely transferred onto the photosensitive drum during passing through the primary transfer portion in a downstream process. Therefore, also in the full-color image forming apparatus of the rotary type, by satisfying a relationship between the pre-brush potential and the temporary collecting brush potential in the constitution of this embodiment, it is possible to obtain a good reversely transferred toner collecting performance by the temporary collecting brush 2 and a charging ghost suppressing effect.

Further, in the above-described embodiments, the bar brush was used as the temporary collecting brush member, but a similar effect can also be obtained by using a brush member consisting of other electroconductive fibers. Specifically, instead of the temporary collecting brush 2, a brush roller prepared by winding electroconductive nylon fibers around a roller-shaped core metal is used, so that the reversely transferred toner can be collected by the brush roller.

Further, in the above-described embodiments, the constitution in which the toner having the negative charge was used and the negative charging voltage is applied was used, but a constitution in which toner having positive charge is used and a positive charging voltage is applied may also be used. In that case, the reversely transferred toner principally has the negative charge, the positive voltage is applied to the temporary collecting brush 2, and the potential relationship in the constitution of this embodiment is satisfied, so that it is possible to obtain a good reversely transferred toner collecting performance by the temporary collecting brush 2 and a charging ghost suppressing effect.

The present disclosure can be realized in processing in which a program for realizing one or more functions in the above-described embodiments is supplied to a system or an apparatus through network or a storage medium and in which one or more processors in a computer of the system or the apparatus read and execute the program. Further, the present disclosure can also be realized by a circuit (for example, ASIC) for realizing one or more functions.

According to the present disclosure, the above-described image defect can be suppressed.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2024-202822, filed on Nov. 20, 2024, which is hereby incorporated by reference herein in its entirety.

What is claimed is:

1. An image forming apparatus in which a first toner image having a first color is formed and a second toner image having a second color different from the first color is transferred onto a toner image receiving member so as to be superposed on the first toner image, the image forming apparatus comprising:
a photosensitive member rotatable in a predetermined rotational direction;
a charging member configured to electrically charge a surface of the photosensitive member in contact with the surface of the photosensitive member;
a developing portion configured to develop an electrostatic latent image, formed on the surface of the photosensitive member, into the second toner image;
a transfer portion configured to transfer the second toner image onto the toner image receiving member;
a collecting member provided downstream of the transfer portion and upstream of the charging member with respect to the rotational direction and configured to electrostatically collect reversely transferred toner which is transferred from the toner image receiving member onto the surface of the photosensitive member by the transfer portion and which has the first color; and
a controller configured to control voltages applied to the charging member and the collecting member, respectively,
wherein an absolute value of a potential of the collecting member during image formation is defined as V1, and an absolute value of a surface potential of the photosensitive member before passing through the collecting member is defined as V2, and
wherein the controller controls each of the voltages applied to the charging member and the collecting member so that
i) V2<V1 is satisfied and (V1−V2) is less than a discharge threshold, and
ii) a potential difference formed between the charging member and the surface of the photosensitive member charged by the collecting member is equal to or higher than a discharge starting voltage.

2. The image forming apparatus according to claim 1, wherein an absolute value of the surface potential of the photosensitive member immediately after passing through the charging member during the image formation is defined as V3, and an absolute value of the surface potential in a non-exposure portion of the photosensitive member after passing through the transfer portion and before passing through the collecting member is defined as V4, and
wherein the controller controls each of the voltages applied to the charging member and the collecting member so that V3<V1 is satisfied and that (V1−V4) is less than the discharge threshold.

3. The image forming apparatus according to claim 2, wherein the photosensitive member includes a charge injection layer containing electroconductive particles, and
wherein the charging member and the collecting member charge the surface of the photosensitive member in contact with the charge injection layer.

4. The image forming apparatus according to claim 3, wherein the controller controls each of the voltages applied to the charging member and the collecting member so that (V1−V4) is less than 350 [V].

5. The image forming apparatus according to claim 3, wherein volume resistivity of the charge injection layer is 1.0×10⁹ [Ω·cm] or more and 1.0×10¹⁴ [Ω·cm] or less.

6. The image forming apparatus according to claim 1, wherein a surface potential of the photosensitive member immediately after passing through the charging member during the image formation is defined as V5, a surface potential of the photosensitive member in an exposed state is defined as V6, and a voltage applied to the transfer portion is defined as V7, and
wherein the controller controls the voltage applied to the charging member so that an absolute value of (V5−V7) is the discharge threshold or more and so that an absolute value of (V6−V7) is the discharge threshold or more.

7. The image forming apparatus according to claim 1, wherein the collecting member includes a supporting member and a brush portion which is mounted to the supporting member, which is constituted by fibers, and with which the photosensitive member is rubbed.

8. The image forming apparatus according to claim 7, wherein a resistance value of the collecting member is 1.0×10⁹ [Ω] or less.

9. The image forming apparatus according to claim 1, wherein the charging member includes a roller constituted by an electroconductive rubber and rotatable by the photosensitive member.

10. The image forming apparatus according to claim 9, wherein the charging member includes a high resistance surface layer having volume resistivity of 1.0×10¹² [Ω·cm] or more, and charges the surface of the photosensitive member by spark discharge.

11. The image forming apparatus according to claim 1, wherein the developing portion electrostatically collects toner remaining on the photosensitive member after the second toner image is transferred on the toner image receiving member by the transfer portion.

12. The image forming apparatus according to claim 1, further comprising a secondary transfer portion configured to transfer the first toner image and the second toner image, which are transferred on the toner image receiving member, onto a sheet.

13. The image forming apparatus according to claim 12, wherein the developing portion electrostatically collects toner remaining on the photosensitive member after the second toner image is transferred on the toner image receiving member by the transfer portion.
